(19) United States
(12) Patent Application Publication
(10) Pub. No.: US 2026/0274291 A1
(43) Pub. Date: Sep. 17, 2026

(54) Autonomous Vehicle Control Device and Method

(71) Applicants: Hyundal Motor Company, Seoul (KR); Kia Corporation, Seoul (KR)

(72) Inventors: Sung Kwan Kim, Hwaseong-Si (KR); Min Sung Kim, Hwaseong-Si (KR); Sung Hwan Yun, Hwaseong-Si (KR); Ji Hong Kim, Hwaseong-Si (KR); Sung Woo Jang, Hwaseong-Si (KR); Dong Gyu Kim, Hwaseong-Si (KR); Seung II Han, Hwaseong-Si (KR)

(21) Appl. No.: 19/325,097

(22) Filed: Sep. 10, 2025

(30) Foreign Application Priority Data
Mar. 11, 2025 (KR) 10-2025-0031168

(51) Int. Cl. B60W 60/00

(52) U.S. Cl. CPC B60W 60/001; B60W 2556/40; B60W 2556/55

(57) ABSTRACT

An apparatus of a vehicle may comprise a processor and a memory storing at least one instruction that, when executed by the processor communicating with the memory, causes the apparatus to obtain, via a transceiver of the vehicle, a plurality of first coordinates indicating a driving path in a first region where driving starts in an arbitrary driving section, obtain a plurality of second coordinates indicating a driving path in a second region where driving ends in the arbitrary driving section, determine a first direction at an entry point, determine a second direction at an end point, output a signal indicating a driving plan path based on the directions, and control, based on the signal, autonomous driving of the vehicle.

### CROSS-REFERENCE TO RELATED APPLICATION

This application claims the benefit of priority to Korean Patent Application No. 10-2025-0031168, filed in the Korean Intellectual Property Office on Mar. 11, 2025, the disclosure of which is incorporated herein by reference in its entirety.

### TECHNICAL FIELD

The disclosure is related to an autonomous vehicle control device and method.

### BACKGROUND

The matters described in this Background section are only for enhancement of understanding of the background of the disclosure, and should not be taken as acknowledgment that they correspond to prior art already known to those skilled in the art

Autonomous vehicles are technology-based vehicles designed to recognize a driving environment and safely and efficiently move through determination and control without intervention of a driver. In order to operate the autonomous vehicles, technology that precisely identifies a location of a vehicle, generates a driving path, and controls the vehicle along the generated path may be used. In particular, an autonomous vehicle may generally travel within an operational design domain (ODD) section, and generate a driving path utilizing a high-definition map (HD map) built in advance within this section. The HD map may enable autonomous vehicles to understand road structures, lane information, traffic signs, traffic lights, and obstacle positions in detail and plan an optimal driving path.

The HD map may allow autonomous vehicles to efficiently cope with complex road situations and safely travel, but the HD map may not be built in advance for all road environments.

In particular, in sections where the HD map has not been built, vehicles may have difficulty generating driving paths. In this case, the autonomous vehicle may use cameras mounted on the vehicle to recognize lane information on the road, generate a driving path (e.g., a center lane) based on the center between lane lines, and travel along the driving path.

However, when the vehicle travels while simply following the center between lane lines in an environment without the HD map, the vehicle may not be able to generate an optimal path depending on the road situations or may follow a driving path that is not suitable for an actual road environment. This may affect safety and driving efficiency in complex road environments, such as curved roads, sections in which lane widths are changed, or sections having obstacles.

Therefore, a technology that allows autonomous vehicles to more safely and efficiently travel even in road environments without the HD map is considered.

### SUMMARY

Various examples of the disclosure provide an autonomous vehicle control device and method capable of generating a driving path based on behavior information about a vehicle in a section where a map is missing.

According to the present disclosure, an apparatus of a vehicle, the apparatus may comprise, a processor, and a memory storing at least one instruction that, when executed by the processor communicating with the memory, is configured to cause the apparatus to, obtain, via a transceiver of the vehicle, a plurality of first coordinates indicating a driving path of the vehicle in a first region where driving of the vehicle starts in an arbitrary driving section, wherein the arbitrary driving section corresponds to a section where map information for controlling driving of the vehicle is missing, obtain, via the transceiver, a plurality of second coordinates indicating a driving path of the vehicle in a second region where driving of the vehicle ends in the arbitrary driving section, determine, based on the plurality of first coordinates, a first direction in which the vehicle is heading at an entry point of the arbitrary driving section, determine, based on the plurality of second coordinates, a second direction in which the vehicle is heading at an end point of the arbitrary driving section, output, based on the first direction and the second direction, a signal indicating a driving plan path of the vehicle in the arbitrary driving section, and control, based on the signal, autonomous driving of the vehicle.

The apparatus, wherein the at least one instruction, when executed by the processor communicating with the memory, is configured to cause the apparatus to, based on an interval of lane center line coordinates being greater than or equal to a preset reference interval, determine that the map information is missing. The apparatus,
wherein the at least one instruction, when executed by the processor communicating with the memory, is configured to cause the apparatus to output the signal indicating the driving plan path of the vehicle in the arbitrary driving section further based on the first coordinates and the second coordinates.

The apparatus, wherein the plurality of first coordinates comprise a coordinate at the entry point of the arbitrary driving section and a coordinate at a point immediately before entering the arbitrary driving section, and the plurality of second coordinates comprise a coordinate at the end point of the arbitrary driving section and a coordinate at a point immediately after the arbitrary driving section ends. The apparatus, wherein the at least one instruction, when executed by the processor communicating with the memory, is configured to cause the apparatus to determine the first direction by comparing the coordinate at the entry point of the arbitrary driving section with the coordinate at the point immediately before entering the arbitrary driving section.

The apparatus, wherein the at least one instruction, when executed by the processor communicating with the memory, is configured to cause the apparatus to determine the second direction by comparing the coordinate at the end point of the arbitrary driving section with the coordinate at the point immediately after the arbitrary driving section ends. The apparatus, wherein the at least one instruction, when executed by the processor communicating with the memory, is configured to cause the apparatus to determine, based on sensor information obtained via the transceiver, lane information associated with the arbitrary driving section.

The apparatus, wherein the at least one instruction, when executed by the processor communicating with the memory, is configured to cause the apparatus to output, based on the lane information, the signal indicating the driving plan path of the vehicle, and wherein the driving plan path may comprise boundary information derived from the lane information. The apparatus, wherein the at least one instruction, when executed by the processor communicating with the memory, is configured to cause the apparatus to determine, based on the driving plan path of the vehicle and the lane information, lane sides of the arbitrary driving section.

The apparatus, wherein the at least one instruction, when executed by the processor communicating with the memory, is configured to cause the apparatus to, based on an angle formed by a virtual center point of the vehicle and the lane sides being greater than or equal to a reference angle, stop outputting the signal indicating the driving plan path of the vehicle.

According to the present disclosure, a method performed by an apparatus of a vehicle, the method may comprise, obtaining, via a transceiver of the vehicle, a plurality of first coordinates indicating a driving path of the vehicle in a first region where driving of the vehicle starts in an arbitrary driving section, wherein the arbitrary driving section corresponds to a section where map information for controlling driving of the vehicle is missing, obtaining, via the transceiver, a plurality of second coordinates indicating a driving path of the vehicle in a second region where driving of the vehicle ends in the arbitrary driving section, determining, based on the plurality of first coordinates, a first direction in which the vehicle is heading at an entry point of the arbitrary driving section, determining, based on the plurality of second coordinates, a second direction in which the vehicle is heading at an end point of the arbitrary driving section, outputting, based on the first direction and the second direction, a signal indicating a driving plan path of the vehicle in the arbitrary driving section, and controlling, based on the signal, autonomous driving of the vehicle.

The method may further comprise, based on an interval of lane center line coordinates being greater than or equal to a preset reference interval, determining that the map information is missing. The method, wherein the outputting of the signal indicating the driving plan path of the vehicle in the arbitrary driving section is further based on the first coordinates and the second coordinates. The method, wherein the plurality of first coordinates comprise a coordinate at the entry point of the arbitrary driving section and a coordinate at a point immediately before entering the arbitrary driving section, and the plurality of second coordinates comprise a coordinate at the end point of the arbitrary driving section and a coordinate at a point immediately after the arbitrary driving section ends.

The method may further comprise, determining the first direction by comparing the coordinate at the entry point of the arbitrary driving section with the coordinate at the point immediately before entering the arbitrary driving section. The method may further comprise, determining the second direction by comparing the coordinate at the end point of the arbitrary driving section with the coordinate at the point immediately after the arbitrary driving section ends. The method may further comprise, determining, based on sensor information obtained via the transceiver, lane information in the arbitrary driving section.

The method, wherein the outputting of the signal indicating the driving plan path of the vehicle may comprise outputting, based on the lane information, the signal indicating the driving plan path of the vehicle, and wherein the driving plan path may comprise boundary information derived from the lane information.

According to the present disclosure, a vehicle may comprise, a sensor, a transceiver, a processor, and a memory storing at least one instruction that, when executed by the processor communicating with the memory, is configured to cause the vehicle to, obtain, via the transceiver, first coordinate data representing a driving path of the vehicle in a first region where the vehicle begins to travel in a road section lacking map information, and second coordinate data representing a driving path of the vehicle in a second region where the vehicle ends the travel in the road section, determine, based on the first coordinate data, a first direction of the travel at an entry point of the road section, determine, based on the second coordinate data, a second direction of the travel at an exit point of the road section, generate driving path data representing a trajectory from the entry point to the exit point, the trajectory satisfying the first direction and the second direction and connecting the entry point to the exit point, identify, based on sensor data obtained from the sensor, a left lane boundary and a right lane boundary in the road section, adjust the driving path data such that the trajectory represented by the driving path data is located between the left lane boundary and the right lane boundary, output a signal indicating the adjusted driving path data, and control, based on the signal, autonomous driving of the vehicle.

The vehicle, wherein at least one instruction, when executed by the processor communicating with the memory, is configured to cause the vehicle to, determine a left lane edge and a right lane edge by, for each of a plurality of points along the trajectory represented by the driving path data, drawing a perpendicular line to the left lane boundary and to the right lane boundary, and identifying intersection points of the perpendicular line and the lane boundaries as the left lane edge and the right lane edge, and based on an angle, formed at a virtual front-center point of the vehicle between a first line segment extending from the virtual front-center point to the left lane edge and a second line segment extending from the virtual front-center point to the right lane edge, being greater than or equal to a threshold angle, stop generation of the driving path data.

### BRIEF DESCRIPTION OF THE DRAWINGS

The above and other objects, features and advantages of the present invention will become more apparent to those of ordinary skill in the art by describing examples thereof in detail with reference to the accompanying drawings, in which:

FIG. 1 is a view showing a vehicle transmitting and receiving data by communicating with other devices;

FIG. 2 is a diagram showing modules constituting a vehicle according to one example of the present disclosure;

FIG. 3 is a diagram for describing the operation of an autonomous vehicle control device according to an example;

FIG. 4, FIG. 5, FIG. 6, FIG. 7 are views for describing the operation of a processor according to the example; and

FIG. 8 is a flowchart of a method of controlling an autonomous vehicle according to an example.

FIG. 9 is an example computing system (e.g., a computing device of a vehicle or any other apparatus).

### DETAILED DESCRIPTION

Hereinafter, preferred examples of the present invention will be described in detail with reference to the accompanying drawings.

However, the technical idea of the present invention is not limited to some examples to be described but may be implemented in various different forms, and within the scope of the technical idea of the present invention, one or more among components in the examples may be used by being selectively combined and substituted.

Further, unless specifically defined and described, terms used in the examples of the present invention (including technical and scientific terms) may be interpreted as meanings which are generally understood by those skilled in the art to which the present invention pertains, and commonly used terms such as terms defined in dictionaries may be interpreted in consideration of the contextual meaning of the related art.

The terms used in the examples of the present invention are for the purpose of describing the examples only and are not intended to limit the invention.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B. In addition, when describing components of examples of the present invention, terms such as first, second, A, B, (a), (b), etc., may be used.

These terms are only for distinguishing the components from other components, and the essence, sequence, or order of the components is not limited by these terms.

In addition, when a component is described as being “linked,” “coupled,” or “connected” to another component, the component is not only directly linked, coupled, or connected to another component, but also “linked,” “coupled,” or “connected” to another component with still another component disposed between the component and the other component.

Further, when a component is described as being formed or disposed “on (above) or under (below)” another component, the term “on (above) or under (below)” includes not only when two components are in direct contact with each other, but also when one or more other components are formed or disposed between the two components. Further, when a component is described as being “on (above) or below (under),” the description may include the meanings of an upward direction and a downward direction based on one component.

Hereinafter, examples will be described in detail with reference to the accompanying drawings, but the same or corresponding components are denoted by the same reference numerals regardless of the drawing numbers, and redundant descriptions thereof will be omitted.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., feature of generating a driving path data in areas lacking HD map data) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., feature of generating a driving path data in areas lacking HD map data) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., feature of generating a driving path data in areas lacking HD map data) described herein.

Minimum risk maneuver (MRM) operation(s) may also be controlled, for example, based on one or more features (e.g., feature of generating a driving path data in areas lacking HD map data) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., feature of generating a driving path data in areas lacking HD map data) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., feature of generating a driving path data in areas lacking HD map data) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving level and/or autonomous driving activation/deactivation may also be controlled, for example, based on one or more features (e.g., feature of generating a driving path data in areas lacking HD map data) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

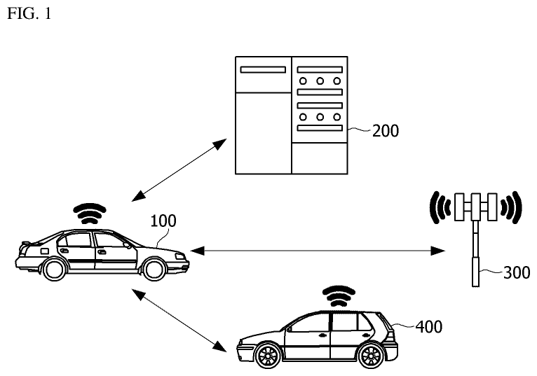

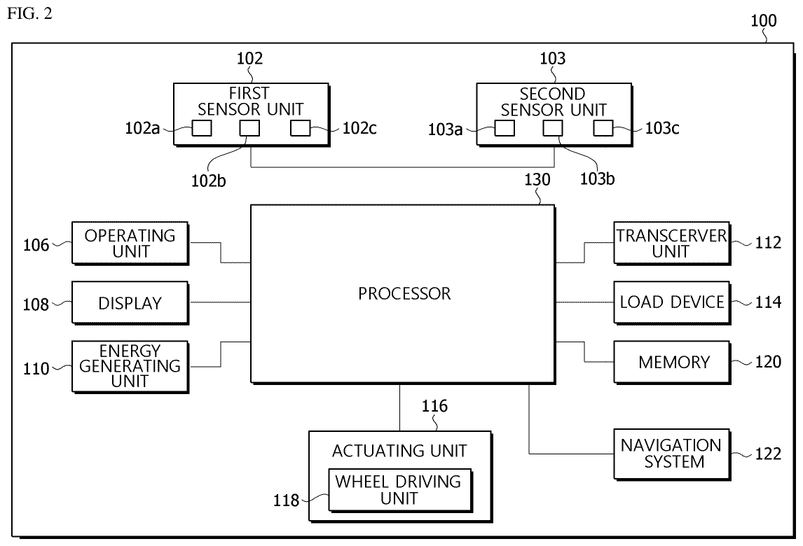

Hereinafter, a vehicle will be described with reference to FIG. 1 and FIG. 2. FIG. 1 is a view illustrating a vehicle transmitting and receiving data by communicating with other devices.

Referring to FIG. 1, a vehicle 100 may be driven based on electrical energy or fossil energy. In the case of electrical energy, the vehicle 100 may be, for example, a pure battery-based vehicle driven only by a high-voltage battery, or may employ a gas-based fuel cell as an energy source. In addition, the fuel cell may use various types of gas capable of generating electrical energy, and the vehicle 100 may be filled with gas in a liquefied state, for example. Here, one example of the gas may be hydrogen. However, the gas is not limited thereto, and various gases are applicable (e.g., methane, ammonia, natural gas, or biogas, etc.). In the case of fossil energy, the vehicle 100 is driven based on fuel such as gasoline, diesel or liquefied gas, and may be equipped with an internal combustion engine that drives an actuating unit 116 by combustion of the fuel. The engine may be included in an energy generating unit 110 in terms of providing a driving rotational force to wheels via a wheel driving unit 118. As another example, the vehicle 100 may drive the actuating unit 116 by selectively utilizing energy from a fossil energy-based internal combustion engine and an electric battery, and may be a hybrid type vehicle (e.g., parallel hybrid, series hybrid, plug-in hybrid, or mild hybrid, etc.).

The vehicle 100 may refer to a movable device. The vehicle 100 is a ground vehicle that travels on the ground and may be a typical passenger car, a commercial vehicle, a purpose-built vehicle (PBV), or the like (e.g., taxi, delivery van, or ride-sharing shuttle, etc.). The vehicle 100 may be a four-wheeled vehicle, such as a passenger car, a sport utility vehicle (SUV), or a small truck, or may be a vehicle with more than four wheels, such as a bus, a large truck, a container transport vehicle, a heavy equipment vehicle, or the like (e.g., dump truck, fire truck, crane, or excavator, etc.). Here, the ground vehicle may be referred to as any vehicle including a vehicle that moves underground as well as a vehicle that moves over land (e.g., subway train, mining vehicle, or tunnel inspection robot, etc.). The vehicle 100 may be a robot in a broad sense, such as a means of movement, and the robot may be moved using wheels, tracks, or other movement modules (e.g., articulated legs, propellers, or air cushions, etc.). In the present disclosure, ground mobility devices such as ground vehicles are mainly described, but unless it contradicts the present disclosure, the present example may also be applied to air mobility devices such as an advance air mobility (AAM), aircraft, or the like (e.g., drones or fixed-wing aircraft, etc.), and water mobility devices such as ships, submarines, or the like (e.g., ferries, underwater drones, or autonomous cargo vessels, etc.).

The vehicle 100 may be controlled and driven by autonomous driving, and the autonomous driving may be implemented as semi-autonomous driving or fully autonomous driving. Fully autonomous driving may be provided as autonomous movement in which a processor 130 of the vehicle 100 takes full control without user intervention, even when a driving situation is uncertain (e.g., poor weather, missing road markings, or sensor blind spots, etc.). Semi-autonomous driving may be provided as autonomous movement that requires driver intervention depending on specific driving situations (e.g., highway merging, construction zones, or unprotected left turns, etc.). The semi-autonomous driving may be implemented so that the processor 130 transfers control to a user by deactivating autonomous driving when the aforementioned situation occurs, allowing the user to perform manual driving. According to the levels of autonomous driving defined by the Society of Automotive Engineers (SAE), the semi-autonomous driving may correspond to autonomous driving levels 1 to 4, and the fully autonomous driving may correspond to level 5.

The vehicle 100 may communicate with other devices 200 and 300 or another vehicle 400. Other devices may include, for example, a server 200 that supports various controls, state management, and driving of the vehicle 100, an intelligent transportation system (ITS) device 300 for receiving information from an ITS, various types of user devices, or the like (e.g., smartphones, smartwatches, or vehicle-mounted tablets, etc.). The server 200 may be, for example, an external device operated by a vehicle manufacturer or provided to service autonomous driving, and may receive connected data of the vehicle 100 or transmit data necessary for autonomous driving. The server 200 may transmit various information and software modules used to control the vehicle 100 to the vehicle 100 in response to requests and data transmitted from the vehicle 100 and the user device to support autonomous driving and various services of the vehicle 100 (e.g., over-the-air updates, traffic predictions, or driving policy parameters, etc.).

The ITS device 300 may be, for example, a roadside unit (RSU), and the ITS device 300 may assist the user in driving his or her host vehicle or support autonomous driving of the vehicle 100 by exchanging vehicle recognition data, driving control and state data, environmental data around the vehicle, map data, or the like, through vehicle-to-infrastructure (V2I) communication with the vehicle 100 (e.g., providing signal timing, road hazard alerts, or dynamic speed limits, etc.). The vehicle 100 may support manual driving or autonomous driving by exchanging the data listed above through vehicle-to-vehicle (V2V) communication with the other vehicle 400 (e.g., for cooperative lane changes, platooning, or collision avoidance, etc.).

The vehicle 100 may communicate with other vehicles or other devices based on cellular communication, wireless access in vehicular environment (WAVE) communication, dedicated short range communication (DSRC), short-range communication, or other communication methods (e.g., Bluetooth, Ultra-Wideband, or satellite-based communication, etc.).

For example, the vehicle 100 may use a cellular communication network such as LTE or 5G, a WiFi communication network, a WAVE communication network, or the like, for communication with the server 200, the ITS device 300, and the other vehicle 400 (e.g., for route updates, map synchronization, or real-time traffic alerts, etc.). For another example, DSRC or the like used in the vehicle 100 may be used for communication between vehicles (e.g., to share braking intentions, lane change signals, or emergency alerts, etc.). The communication method between the vehicle 100, the server 200, the ITS device 300, the other vehicle 400, and the user device is not limited to the above-described example and may include alternative protocols or emerging standards (e.g., CV2X, mmWave, or satellite IoT, etc.).

FIG. 2 is a diagram showing modules constituting a vehicle according to one example of the present disclosure.

The vehicle 100 may include a sensor unit 102, an operating unit 106, a display 108, a load device 114, and a transceiver unit 112.

The sensor unit 102 may be provided with various types of detectors to detect various states and situations occurring in an external environment, an internal system, user operation, and a boarding space of the vehicle 100 (e.g., road conditions, cabin temperature, driver behavior, or passenger presence, etc.).

Specifically, the first sensor unit 102 may be provided with an externally oriented camera 102a, a lidar sensor 102b, a radar sensor 102c, and the like, to recognize dynamic and static objects present outside the vehicle 100 (e.g., other vehicles, pedestrians, road signs, or curbs, etc.). The camera 102a may recognize an external object as an image while the vehicle 100 is in use, generate image data, and transmit the image data to the processor 130. The lidar sensor 102b may generate point cloud data as recognized data of the external object and transmit the point cloud data to the processor 130 to generate 3D spatial information that identifies at least a shape of the external object (e.g., outlines of vehicles, barriers, or surrounding structures, etc.). In order to ascertain the presence of an external object and its relative distance, speed, direction, or the like, the radar sensor 102c may emit radio waves of a specific frequency around the vehicle 100 and generate radar data through radio waves reflected from the external object (e.g., for tracking vehicles in blind spots, detecting cross traffic, or monitoring adjacent lanes, etc.). In the present disclosure, the sensor unit is illustrated as having the lidar sensor 102b, but in other examples, the lidar sensor 102b may not be mounted.

The first sensor unit 102 may generate object recognition information based on sensing data. The object recognition information may include information on the presence of an object, position information about the object, information on a distance between the vehicle 100 and the object, and information on a relative speed between the vehicle 100 and the object (e.g., approaching vehicle speed, pedestrian crossing timing, or merging vehicle gaps, etc.). In the example, external objects may be various objects related to the operation of the vehicle 100 (e.g., moving vehicles, parked vehicles, road debris, or cyclists, etc.).

A second sensor unit 103 may be provided with a positioning sensor 103a, a wheel sensor 103b, an attitude sensor 103c, and the like, to confirm its own location, speed, driving attitude, and the like. (e.g., for localization, motion control, or safety verification, etc.) The attitude sensor 103c may include a gyro sensor, an angular velocity sensor, an acceleration sensor, or the like. The attitude sensor may be an inertial measurement unit (IMU) sensor and may be equipped with a 3-axis accelerometer and a 3-axis gyroscope (e.g., for estimating changes in heading, tilt, or orientation during turns, hills, or lane changes, etc.). The attitude sensor may measure acceleration in a traveling direction (x), acceleration in a lateral direction (y), and acceleration in a height direction (z) of the vehicle 100, and a yaw, a pitch, and a roll as the angular velocity of the vehicle.

The second sensor unit 103 may generate vehicle driving information based on sensing data. The vehicle driving information may be information generated based on data detected by various sensors installed inside the vehicle (e.g., sensors embedded in the drivetrain, steering column, pedals, or cabin environment, etc.). For example, the vehicle driving information may include vehicle attitude information, vehicle speed information, vehicle inclination information, vehicle weight information, vehicle direction information, vehicle battery information, vehicle fuel information, vehicle tire pressure information, vehicle steering information, vehicle interior temperature information, vehicle interior humidity information, pedal position information, vehicle engine temperature information, and the like (e.g., coolant level, brake fluid pressure, or regenerative braking status, etc.).

In addition, the vehicle driving information may include path information. The path information may refer to information generated based on a destination input by a vehicle user through the operating unit 106. The path information may refer to information that indicates a traveling path from a current position of a host vehicle to a destination on a map when the destination has been set (e.g., navigation routes, alternative paths, or traffic-optimized routes, etc.). When no destination is set, the path information may refer to information including a road on which the host vehicle is currently traveling and a future driving path including the road (e.g., predicted lane changes, speed profiles, or planned deceleration zones, etc.).

The operating unit 106 may be configured as a module that is controlled by the user for driving. For example, the operating unit 106 may be a steering wheel for manual driving, an automatic or manual shift transmission, an accelerator pedal, a brake pedal, or the like (e.g., gear selector dial, paddle shifter, or joystick controller, etc.). The operating unit 106 may be further provided with an interface for enabling or disabling an autonomous driving mode and selecting detailed functions requested by the user so that the user may use an autonomous driving function (e.g., activating adaptive cruise control, selecting a driving profile, or requesting self-parking, etc.). In order to receive various requests related to autonomous driving, the operating unit 106 may be configured, for example, as a hard-type interface provided at a predetermined position inside the vehicle 100, or as a soft-type interface that may be touched on the display 108 (e.g., touchscreen controls, rotary knobs with embedded screens, or haptic feedback panels, etc.). Depending on the specifications of the autonomous vehicle, at least one of the steering wheel, the transmission, and the pedal may be omitted (e.g., in Level 5 vehicles with no manual override hardware, etc.). For another example, the operating unit 106 may be provided with a module that receives a user's control request for the load device 114 in addition to driving control (e.g., adjusting climate settings, controlling cabin lighting, or opening a trunk, etc.).

The display 108 may function as a user interface. The display 108 may output and display an operating state, a control state, path/traffic information, remaining energy amount information, content requested by the driver, or the like, of the vehicle 100 by the processor 130 (e.g., current gear, battery level, turn-by-turn directions, or media playback status, etc.). In addition, the display 108 may be configured as a touch screen capable of detecting a driver's input to receive a driver's request to instruct the processor 130 (e.g., entering a destination, selecting a driving mode, or adjusting climate control settings, etc.).

The load device 114 is mounted on the vehicle 100 and may be a type of non-driving electrical device excluding a driving power system such as the wheel driving unit 118 or the like. The load device 114 is an auxiliary device that receives electrical power from the energy generating unit 110, and may be, for example, an air conditioning system, a lighting system, a seat system, various devices installed in the vehicle 100, or the like (e.g., infotainment displays, power windows, door locks, or ambient lighting, etc.). In the present disclosure, a cooling/heating system that cools or heats at least one of a battery, a fuel cell, an internal combustion engine, an air conditioning system, and a specific part of the vehicle 100 may be further included (e.g., thermal management for a lithium-ion battery, preconditioning a fuel cell stack, or heating a windshield camera, etc.).

The transceiver unit 112 may support mutual communication with the server 200, the ITS device 300, nearby vehicles 400, and the like (e.g., for cooperative maneuvering, cloud-based updates, or traffic signal coordination, etc.). The transceiver unit 112 may include a module that processes, for example, cellular communication, WAVE, DSRC communication, and the like (e.g., 5G-V2X, IEEE 802.11p, or Bluetooth Low Energy, etc.). In the present disclosure, the transceiver unit 112 may transmit data generated or stored while driving to the server 200 and receive data and software modules transmitted from the server 200 (e.g., updated navigation maps, control policy changes, or diagnostic reports, etc.). The transceiver unit 112 may support communication with an electronic device carried by an occupant inside the vehicle 100 (e.g., a smartphone, smartwatch, or tablet, etc.). In the present disclosure, the vehicle 100 may transmit and receive data utilized in a method according to the present disclosure to and from the outside through the transceiver unit 112.

For example, the transceiver unit 112 may receive traffic signal information from a traffic signal controller and provide the traffic signal information to the processor 130 (e.g., signal phase and timing, pedestrian crossing status, or countdown indicators, etc.). In addition, the transceiver unit 112 may receive a control signal from the traffic signal controller and provide the control signal to the processor 130 (e.g., lane-specific green light permissions or emergency vehicle override commands, etc.).

In addition, the vehicle 100 may include the energy generating unit 110 and the actuating unit 116 (e.g., battery and inverter systems, or motor and drivetrain assemblies, etc.).

The energy generating unit 110 may generate and supply power and electric power used in a driving power system and a non-driving power system, such as the actuating unit 116. The non-driving power system may be, for example, the sensor unit 102, the operating unit 106, the display 108, the load device 114, and the transceiver unit 112, but is not limited thereto, and may include various components that implement sensing, interface, communication, and convenience functions, excluding components directly involved in driving operations (e.g., cabin lighting, infotainment systems, electronic door locks, or climate control sensors, etc.). When the vehicle 100 is driven based on electrical energy, the energy generating unit 110 may be configured as an electric battery charged from the outside, or configured as a combination of an electric battery and a fuel cell that charges the electric battery. In the case of the combination of the electric battery and the fuel cell, the energy generating unit 110 may include a tank that stores materials used to produce electric power for the fuel cell, such as liquefied hydrogen (e.g., high-pressure hydrogen tanks, methanol reformers, or ammonia-based fuel carriers, etc.). When the vehicle 100 is driven based on fossil energy, the energy generating unit 110 may be configured as an internal combustion engine (e.g., gasoline engine, diesel engine, or natural gas engine, etc.). In addition, when the vehicle 100 is a hybrid type, the energy generating unit 110 may be provided as a combination of the internal combustion engine and the electric battery (e.g., in series hybrid, parallel hybrid, or plug-in hybrid configurations, etc.).

The actuating unit 116 may be provided with at least one module that implements driving operations and perform at least one driving operation among longitudinal control such as acceleration and deceleration and lateral control such as steering, according to a user request from the operating unit 106. In order to perform driving operations according to a command of the processor 130 by manual operation of the user or autonomous driving, the actuating unit 116 may be provided with the wheel driving unit 118 and mechanical components and electronic modules for implementing the driving operations in the wheel driving unit 118 (e.g., electric motors, steering actuators, or regenerative braking modules, etc.). When the vehicle 100 is operated based on electrical energy, the actuating unit 116 may include an assembly for transmitting the requested driving operation to the wheel driving unit 118 (e.g., inverter control systems, torque vectoring assemblies, or single-speed gearboxes, etc.). When the vehicle 100 is operated based on fossil energy, the actuating unit 116 may be provided with a transmission and a gear module that transmit the power of the internal combustion engine (e.g., multi-speed automatic transmission, continuously variable transmission, or dual-clutch transmission, etc.).

The wheel driving unit 118 may include a plurality of wheels, a driving force generation module for generating a driving force and applying the driving force to the wheels or transmitting the driving force, a braking module for slowing down the driving of the wheels, and a steering module for carrying out lateral control of the wheels (e.g., rack-and-pinion system, steer-by-wire, or rear-wheel steering, etc.). When the vehicle 100 is driven based on electrical energy, the driving force generating module may be configured as a motor assembly that generates a driving force based on electric power output from the electric battery (e.g., front-axle motor, rear-axle motor, or in-wheel motors, etc.). The braking module of the electric-based vehicle 100 may further have a regenerative braking function (e.g., capturing kinetic energy during deceleration and converting it to stored battery energy, etc.).

A navigation system 122 may provide navigation information. The navigation information may include at least one of map information, set destination information, path information according to a set destination, information on various objects on the path, lane information, and current vehicle position information (e.g., intersection locations, traffic congestion data, lane-level guidance, or rest stops along the route, etc.).

The navigation system 122 may receive information from an external device through the transceiver unit 112 and update previously stored information (e.g., receiving updated map tiles, real-time traffic overlays, or detour alerts, etc.). According to the example, the navigation system 122 may be classified as a sub-component of the operating unit 106.

In addition, the vehicle 100 may include a memory 120 and the processor 130 (e.g., storing driving history, sensor calibration data, or machine learning model weights, etc.).

The memory 120 may store applications and various types of data for controlling the vehicle 100, and load applications or read and record data by a request of the processor 130.

The processor 130 may perform overall control of the vehicle 100. The processor 130 may be configured to execute applications and instructions stored in the memory 120 (e.g., decision-making algorithms, path planning routines, or sensor fusion logic, etc.).

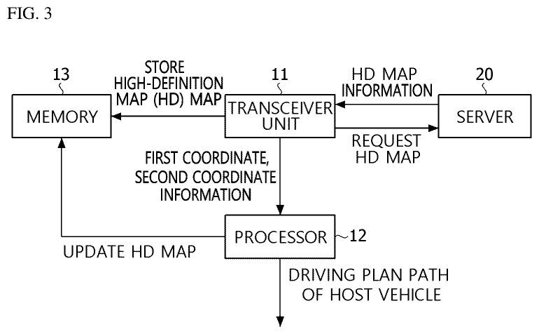

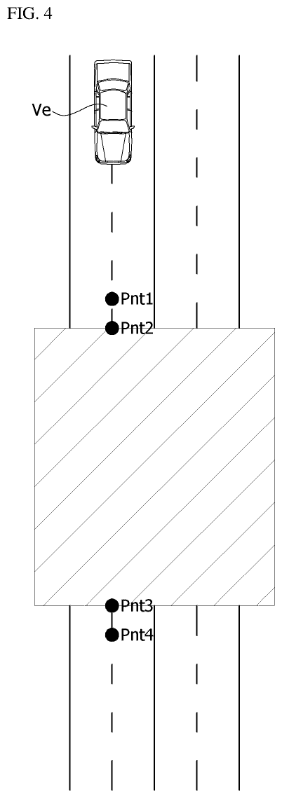

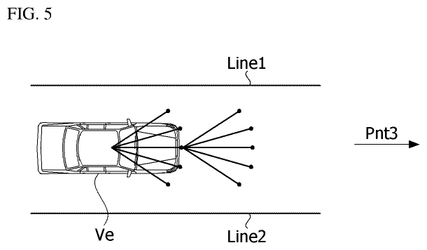

FIG. 3 is a diagram for describing the operation of an autonomous vehicle control device according to an example. An autonomous vehicle control device 10 according to the example may include a transceiver unit 11, a processor 12, and a memory 13. The transceiver unit 11, the processor 12, and the memory 13 of the autonomous vehicle control device 10 may each have the same configuration as the transceiver unit, the processor, and the memory illustrated in FIG. 2 (e.g., enabling wireless data exchange, centralized path planning, or real-time execution of control logic, etc.).

The autonomous vehicle control device 10 according to the example may generate a driving plan path utilizing behavior information and coordinate information about a host vehicle in the arbitrary driving section where the host vehicle is traveling. Such a driving plan path may be particularly usefully applied to sections where map information is not generated or is missing (e.g., construction zones, rural roads, or newly developed urban areas, etc.). The autonomous vehicle control device 10 according to the example is described using a section where high-definition map (HD map) information is missing as one example, but it may be considered to be within the technical scope of the present invention that, unlike this example, the autonomous vehicle control device 10 may be applied even in a section where a general map is missing, and may also be applied even in a section where map information is not missing (e.g., for redundancy checking, route recalibration, or localized path refinement, etc.).

The HD map may refer to an electronic map in which information on lane lines (regulation lines, road boundary lines, stop lines, and center lines of lanes), road facilities (median strips, tunnels, bridges, and underpasses), and sign facilities (traffic safety signs, road markings, and traffic signals) necessary for autonomous driving is produced with an accuracy of within several tens of centimeters (e.g., 10 cm, 20 cm, or 30 cm, etc.).

The HD map may be generated based on data collected in an autonomous vehicle using a lidar, a camera, an inertial measurement unit (IMU), a radar sensor, and the like to detect an environment around the vehicle (e.g., to identify lane geometry, intersection structure, or roadside obstacles, etc.). The autonomous vehicle may align and integrate various sensor data, and analyze information collected from each sensor in the same coordinate system through the integrated data to extract key features such as road boundaries, lane lines, traffic lights, signs, and the like (e.g., stop signs, yield markings, or pedestrian crossings, etc.). The autonomous vehicle may generate a high-definition local map of surroundings of the vehicle and transmit the high-definition local map to a server 20.

The server 20 may generate the HD map by integrating data collected in multiple vehicles to form an overall road network (e.g., a crowdsourced city-wide or nationwide road map, etc.). The HD map may include topographic information such as road boundaries, lane line positions, center lines, crosswalks, or the like, static object information such as buildings, guardrails, traffic signs, traffic lights, or the like, road network information matched to GPS coordinates, and detailed level information such as a road slope, curvature, width, or the like (e.g., 3D elevation profiles, grade transitions, or sharp turn geometry, etc.).

The autonomous vehicle may continuously collect data while traveling and upload the collected data back to the server 20 to reflect changes (e.g., construction updates, road wear, or repositioned signage, etc.). The server 20 may detect changes by comparing newly collected data with an existing HD map and update the changes to maintain the efficiency of the entire system (e.g., real-time updates pushed to vehicles, or periodic map versioning to maintain accuracy, etc.).

The transceiver unit 11 receives the HD map from the server 20, and the vehicle may perform real-time traveling based on the received HD map. The vehicle may match data collected while traveling with the HD map to accurately identify its position and plan a driving path (e.g., aligning lidar features with lane geometry, adjusting for GPS drift, or recognizing upcoming intersections, etc.).

The HD map received from the server 20 may be combined with information detected by a sensor of the vehicle to be utilized for localization and path planning of the vehicle (e.g., combining camera and radar inputs with HD map lane boundaries or signal phases, etc.).

When the vehicle starts traveling, the transceiver unit 11 may request necessary HD map data from the server 20 based on a current position (e.g., using GPS data or initial localization results, etc.). When requesting the HD map, the transceiver unit 11 may transmit current GPS coordinates and a movement path (or destination information) together to the server 20 (e.g., to retrieve only the HD map tiles relevant to a trip corridor, etc.).

Corresponding to the request, the server 20 may prepare HD map data corresponding to a requested range of the vehicle. The server 20 may filter the necessary HD map data based on the position and the requested range of the vehicle. This is a necessary process to minimize the data transmission amount and maximize efficiency (e.g., avoiding full-map downloads by sending only nearby road segments, etc.). For example, when the vehicle requests road and environment data within a 5 km radius from its current location, the server 20 may prepare only HD map data corresponding to a corresponding area and transmit the prepared HD map data to the vehicle (e.g., including only road lanes, crosswalks, and objects within that radius, etc.).

The server 20 may minimize network bandwidth usage by compressing or lightening the HD map data before transmission (e.g., through binary encoding, lossy compression of non-critical metadata, or downsampling of terrain mesh, etc.). For example, the server 20 may pre-cache HD map data of frequently used areas to quickly provide the data when needed, and may delay transmission of relatively less important data (e.g., low-priority roadside object details or backup routes, etc.).

The server 20 may transmit the filtered HD map data to the vehicle according to the request. The data may generally be provided in a tile-based structure. That is, the map data may be divided into small block (tile) units so that only the necessary parts may be provided to the vehicle (e.g., 100 m×100 m tiles containing road geometry, traffic signs, and curvature annotations, etc.).

The HD map may define an object using a map coordinate system (e.g., using global UTM coordinates, local reference frames, or lane-relative positions, etc.).

For example, lane coordinate points may represent the center line, boundary line, or edge of a lane, and each lane may be defined as a set of contiguous coordinate points (e.g., spaced every 0.5 m, 1 m, or 2 m along the road, etc.).

For example, the lane center line may be constructed in the following manner: Point A(X₁, Y₁)→Point B(X₂, Y₂)→Point C(X₃, Y₃) (e.g., forming a polyline approximation of a curved or straight lane, etc.).

Road object coordinate points may define a position of a fixed road object such as a road sign, a traffic light, a guardrail, a tree, a building, or the like, and may be defined as coordinates representing a center point or boundary of the object (e.g., pole center for a traffic light, bounding box edge for a building, or curb anchor point for a guardrail, etc.).

Road path coordinate points may define a driving path in which a curvature, slope, width, and the like of the road are reflected (e.g., bank angle, lane expansion, vertical profile, etc.).

Reference points may represent key points, such as intersections or junctions, in a road network and may be used as reference points when the vehicle resets its position or recalculates its path (e.g., T-intersections, highway merges, or roundabouts, etc.).

The coordinate points of the HD map may generally be defined at intervals of several tens of centimeters to several meters (e.g., 25 cm, 50 cm, or 1 m resolution, etc.).

The transceiver unit 11 may store the HD map data received from the server 20 in the memory 13, and the processor 12 may integrate the previously stored HD map data and the newly received HD map data (e.g., by updating only changed tiles or merging new layers with the existing local map, etc.).

The processor 12 may compare already stored data with new data to remove duplicates and update the HD map data to the latest version (e.g., eliminating redundant object markers or refreshing outdated lane geometry, etc.).

The processor 12 may determine an exact position of the vehicle by comparing real-time data collected from sensors (the lidar, the camera, and the like) of the vehicle with the HD map received from the server 20 (e.g., aligning detected lane lines, traffic signs, or road edges with their mapped counterparts, etc.).

In addition, the processor 12 may plan an optimal path based on the HD map data and adjust the path in real time according to obstacles or road situations (e.g., avoiding parked vehicles, construction zones, or lane closures, etc.).

The transceiver unit 11 may collect a plurality of first coordinates indicating the driving path of the host vehicle in a first region where the driving of the host vehicle is started in an arbitrary driving section and collect a plurality of second coordinates indicating the driving path of the host vehicle in a second region where the driving of the host vehicle ends in the arbitrary driving section (e.g., beginning and end points of a section where HD map data is missing or path refinement is needed, etc.). In the example, the driving path or driving plan path of the host vehicle may refer to a line generated by connecting the center lines of lanes on the HD map (e.g., to represent the predicted or intended trajectory of the vehicle, etc.).

The processor 12 may determine a first direction in which the host vehicle is heading at an entry point of the arbitrary driving section using the first coordinates and determine a second direction in which the host vehicle is heading at an end point of the arbitrary driving section using the second coordinates (e.g., for continuity of motion, orientation alignment, or heading constraint enforcement, etc.).

In the example, the arbitrary driving section may refer to a section where the HD map information is missing. In the following description, the arbitrary driving section and the section where the HD map information is missing may refer to the same section (e.g., tunnels, rural backroads, construction zones, or newly developed neighborhoods, etc.).

The processor 12 may determine that the map information is missing if the interval of the lane center line coordinates is greater than or equal to a preset reference interval. For example, the processor 12 may determine that the HD map is missing in the corresponding section if a collection interval of lane coordinate points is greater than or equal to a preset reference interval of n[m] (e.g., if coordinate spacing suddenly increases from 0.5 m to 5 m, etc.). In this case, a reference interval may be set based on the collection interval of coordinate information in the section where HD map information is normally received. For example, the processor 12 may determine an average value of the collection intervals of coordinate information in a section where the HD map information is normally received, and set 1.5 times the determined average value as the reference interval (e.g., if the average interval is 1 m, the threshold becomes 1.5 m, etc.). Accordingly, the processor 12 may determine a section where the HD map is missing between any two coordinates when the interval between the two coordinates is 1.5 times the above-mentioned average value (e.g., suggesting a gap in coverage or data loss, etc.).

In the example, the first coordinate and the second coordinate may refer to lane coordinate points. The first coordinate may refer to pieces of coordinate information around a start point of the section where the HD map is determined to be missing, and the second coordinate may refer to pieces of coordinate information around an end point of the section where the HD map is determined to be missing (e.g., defined by available HD map segments that bookend the missing region, etc.).

For example, the first coordinates may include a coordinate at the entry point of the arbitrary driving section and a coordinate at a point directly before entering the arbitrary driving section, and the second coordinates may include a coordinate at the end point of the arbitrary driving section and a coordinate at a point directly after the arbitrary driving section ends (e.g., to ensure continuity in both geometry and orientation, etc.).

The processor 12 may generate the driving plan path of the host vehicle in the arbitrary driving section using the first coordinates, the second coordinates, the first direction, and the second direction (e.g., by interpolating a trajectory consistent with known entry/exit positions and headings, etc.). In the example, the driving plan path of the host vehicle may refer to the center line of a lane, and may refer to the center line of a lane virtually generated in the section where the HD map is missing (e.g., estimated using past trajectories, lane detection, or environmental cues, etc.). The driving plan path of the host vehicle may be determined from coordinate points spaced at intervals of tens of centimeters to several meters (e.g., 25 cm, 50 cm, or 1 m, depending on localization precision, etc.).

The processor 12 may determine the first direction by comparing the coordinate at the entry point of the arbitrary driving section with the coordinate at the point directly before entering the arbitrary driving section (e.g., by forming a heading vector between consecutive lane points, etc.). The processor 12 may determine the first direction through a vector operation between the coordinate at the entry point of the arbitrary driving section and the coordinate at the point directly before entering the arbitrary driving section (e.g., by computing a normalized direction vector or heading angle, etc.).

In addition, the processor 12 may determine the second direction by comparing the coordinate at the end point of the arbitrary driving section with the coordinate at the point directly after the arbitrary driving section ends. The processor 12 may determine the second direction through a vector operation between the coordinate at the end point of the arbitrary driving section and the coordinate at the point directly after the arbitrary driving section ends (e.g., using forward finite differencing or waypoint projection, etc.).

The first direction and the second direction may include angle information indicating a direction in which the vehicle is traveling (e.g., heading angle with respect to north, lane orientation, or local tangent angle, etc.).

The processor 12 may determine lane information in the arbitrary driving section using camera information collected through the transceiver unit 11 (e.g., identifying painted lane markings, curb edges, or other road boundaries in image data, etc.).

The processor 12 may generate the driving plan path of the host vehicle using the lane information as a boundary. That is, the processor 12 may generate the driving plan path of the host vehicle within left lane information and right lane information determined through the camera (e.g., based on detected solid or dashed lines, guardrails, or curb lines, etc.).

The processor 12 may determine lane sides using the driving plan path of the host vehicle and lane information (e.g., by projecting perpendicular vectors from points along the trajectory to the lane boundaries, etc.).

In addition, the processor 12 may stop generating the driving plan path of the host vehicle if an angle formed by a virtual center point based on the host vehicle and the lane sides is greater than or equal to a reference angle (e.g., 160°, 170°, or 180°, indicating possible lane loss or extreme curvature, etc.). In the example, the virtual center point may be formed on a front bumper of the host vehicle, and may refer to a center point of a width of the front bumper (e.g., the midpoint between the left and right headlight edges, etc.).

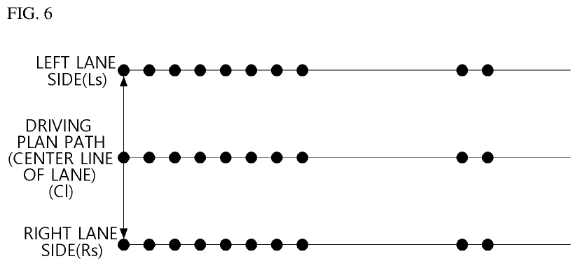

FIG. 4, FIG. 5, FIG. 6, FIG. 7 are views for describing the operation of the processor according to the example.

A hatched region in FIG. 4 may indicate a section where a HD map is missing. Referring to FIG. 4, a first coordinate may include coordinate information on Pnt1 and Pnt2, and a second coordinate may include coordinate information on Pnt3 and Pnt4.

Pnt2 may be a coordinate for a start point of a section where the HD map is missing, and Pnt3 may be a coordinate for an end point of a section where the HD map is missing. Pnt1 may be coordinate information at a point immediately before Pnt2, and Pnt4 may be coordinate information at a point immediately after Pnt3 (e.g., the last available HD map point before the gap and the first available HD map point after the gap, etc.).

The processor 12 may determine a first direction through vector operations using the Pnt1 and Pnt2 coordinates, and may determine a second direction through vector operations using the Pnt3 and Pnt4 coordinates. For example, the processor 12 may determine the first direction and the second direction according to the following Equation 1.

$$θ = a tan 2 ( Δ Y , Δ X ) \qquad [ Equation 1 ]$$

In Equation 1, the processor 12 may use the a tan 2 function to receive a Y-axis change amount (ΔY) and an X-axis change amount (ΔX) between Pnt1 and Pnt2 and determine an angle that a vector makes with the X-axis to derive the first direction. In addition, the processor 12 may receive a Y-axis change amount (ΔY) and an X-axis change amount (ΔX) between Pnt3 and Pnt4 and determine an angle that a vector makes with the X-axis to derive the second direction.

The first and second directions are output in radians, and may have values ranging from −π to π (or −180° to 180°).

Referring to FIG. 5, the processor 12 may generate a curve satisfying the first direction and the second direction by connecting coordinates at an entry point and an end point of the section where the HD map is missing and determine the generated curve as a driving plan path of a host vehicle Ve (e.g., approximating a likely lane centerline in the absence of HD map data, etc.). For example, the processor 12 may generate the curve connecting the coordinates at the entry and end points of the section where the HD map is missing using a third-order spline or a fifth-order spline (e.g., cubic or quintic spline interpolation for smooth trajectory fitting, etc.).

Path generation using the third or fifth splines is a method of generating a smooth curve that satisfies the start point Pnt2, the end point Pnt3, and a direction (heading) and curvature (Curvature) at each point. The processor 12 may set a spline equation based on input data (e.g., start/end coordinates, direction, velocity, heading angle, acceleration, or the like) and determine spline coefficients to satisfy given constraints (e.g., continuity, vehicle kinematics, road structure, road geometry, and the like). The generated curve may smoothly follow changes in road curvature, and may provide a path suitable for driving characteristics of the vehicle Ve. The processor 12 may sample the spline at regular intervals and convert the samples into a list of points that the vehicle may follow (e.g., for waypoint tracking or control input generation, etc.).

Alternatively, the processor 12 may sample a plurality of paths available for driving from the entry point Pnt2 and the end point Pnt3 of the section where the HD map is missing, evaluate the sampled paths, and select a most suitable or optimal path. For example, the processor 12 may generate a driving plan path by applying an algorithm such as a rapidly-exploring random tree (RRT) or probabilistic roadmap (PRM) (e.g., to handle complex or obstacle-laden environments, etc.).

The RRT is an algorithm that generates a tree by expanding randomly sampled points from a start position and searches for a connectable path until the vehicle reaches the end point, and may form the path by selecting only points without obstacles. The path may be improved to be a shorter and smoother path through an optimization stage (e.g., pruning redundant nodes or smoothing sharp corners, etc.).

The PRM may represent a road environment in the form of a graph using randomly sampled points, form a path network through connections between adjacent points, and then find an optimal path by connecting the start and end points to the network.

The processor 12 may define the vehicle driving plan path generated through the aforementioned process as the center line of the lane in the section where the HD map is missing (e.g., as a virtual reference line used for vehicle localization, trajectory following, or lane-level path planning, etc.).

In this case, the processor 12 may generate the driving plan path of the host vehicle Ve using pieces of lane information Line1 and Line2 as boundaries. That is, the processor 12 may generate the driving plan path of the host vehicle within left lane information Line1 and right lane information Line2 determined through the camera (e.g., from lane markers, curbs, or roadside boundaries, etc.).

In addition, the processor 12 may control the behavior of the host vehicle according to the generated driving plan path. The processor 12 may control parameters such as lateral acceleration, longitudinal acceleration, a steering angle, or braking force, etc., of the vehicle to follow the driving plan path.

Referring to FIG. 6 together, the processor 12 may determine lane sides Ls and Rs using the driving plan path of the host vehicle and lane information. The processor 12 may generate perpendicular lines from a driving plan path CI of the host vehicle Ve to the lanes on both sides, and may determine a set of feet of the perpendicular lines formed by the perpendicular lines as the lane sides Ls and Rs. That is, the processor 12 may determine a left lane side Ls by connecting points where a straight line extending from each of points constituting the driving plan path CI of the host vehicle is perpendicular to the left lane (e.g., a left boundary line or dashed lane marker, etc.). Likewise, the processor 12 may determine a right lane side Rs by connecting points where a straight line extending from each of a plurality of points constituting the driving plan path CI of the host vehicle is perpendicular to the right lane (e.g., a solid shoulder line or adjacent vehicle lane, etc.).

Referring to FIG. 7 together, the processor 12 may stop generating the driving plan path of the host vehicle if an angle formed by a virtual center point based on the host vehicle and the lane sides is greater than or equal to a reference angle (e.g., when approaching a sharp curve, an intersection, or a road fork, etc.). In the example, the virtual center point may be formed on a front bumper of the host vehicle, and may refer to a center point of a width of the front bumper (e.g., the midpoint between the left and right corners of the bumper, etc.). The processor 12 may stop generating the driving plan path of the host vehicle if an included angle θ between line segments connecting the left lane side and the right lane side with the virtual center point as a vertex is greater than or equal to the reference angle (e.g., due to sharp curves, forks, or uncertain road geometry, etc.). For example, the processor 12 may stop generating the driving plan path of the host vehicle if the angle formed by the virtual center point and the lane sides is 175 degrees or more.

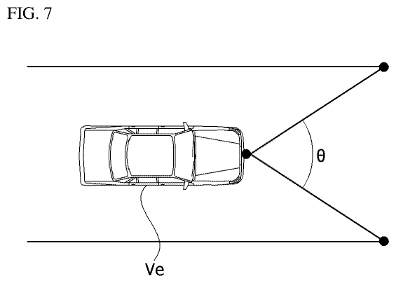

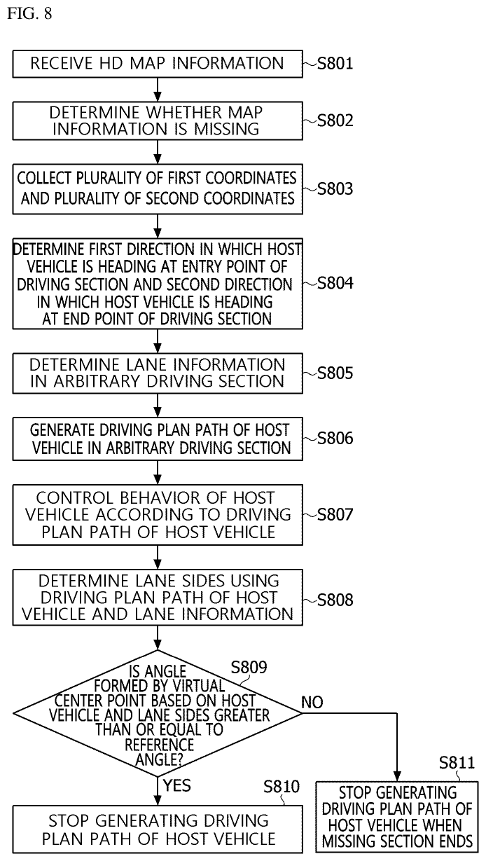

FIG. 8 is a flowchart of a vehicle driving method according to an example. Referring to FIG. 8, the transceiver unit receives HD map information from the server (S801).

The processor determines that map information is missing if an interval of lane center line coordinates is greater than or equal to a preset reference interval using coordinate information of the HD map information (S802) (e.g., if coordinate intervals exceed 1.5 times the average spacing in normal map sections, etc.).

When the HD map information is missing, the transceiver unit collects a plurality of first coordinates representing coordinates of a lane center line in a first region where a section where the HD map information is missing starts, and collects a plurality of second coordinates representing coordinates of a lane center line of the host vehicle in a second region where the section where the HD map information is missing ends (S803) (e.g., Pnt1/Pnt2 for entry, Pnt3/Pnt4 for exit, etc.).

Next, the processor determines a first direction in which the host vehicle is heading at an entry point of the arbitrary driving section using the first coordinates and determines a second direction in which the host vehicle is heading at an end point of the arbitrary driving section using the second coordinates (S804) (e.g., using vector angles between consecutive lane coordinates, etc.).

Next, the processor determines lane information in an arbitrary driving section using camera information (S805) (e.g., camera-captured image data such as lane markers, road boundaries, or painted guidelines, etc.).

Next, the processor generates a driving plan path of the host vehicle in the arbitrary driving section using the first coordinates, the second coordinates, the first direction, and the second direction. In this case, the processor generates the driving plan path of the host vehicle using the lane information as a boundary (S806) (e.g., using left and right lane boundaries as constraints, etc.).

The processor controls the behavior of the host vehicle to follow the generated driving plan path of the host vehicle (S807) (e.g., by adjusting steering, braking, and acceleration, etc.).

Next, the processor determines lane sides using the driving plan path of the host vehicle and the lane information (S808) (e.g., by projecting perpendiculars from each trajectory point to adjacent lanes, etc.).

Next, the processor stops generating the driving plan path of the host vehicle if an angle formed by a virtual center point based on the host vehicle and the lane sides is greater than or equal to the reference angle (S809 and S810) (e.g., 175 degrees, or if deviation from lane edges exceeds threshold, etc.).

Alternatively, the processor stops generating the driving plan path of the host vehicle when the section where the HD map information is missing ends (S811) (e.g., upon re-entry into a mapped region, etc.).

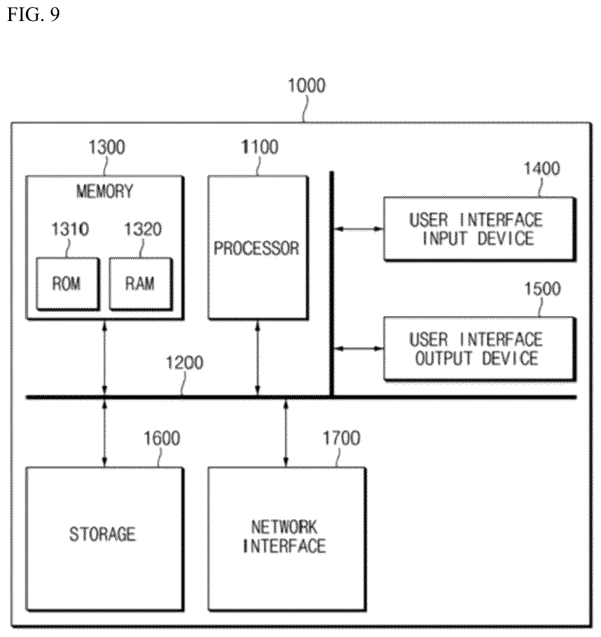

FIG. 9 shows an example computing system (e.g., a computing device of a vehicle or any other apparatus). One or more controllers, processors, etc. described herein, such as one or more components of the vehicle 100 and any other components and devices disclosed herein, may be implemented by or in the computing system as shown in FIG. 9. A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The term “~unit” used in the present example refers to software components or hardware components such as a field-programmable gate array (FPGA) or an application specific integrated circuit (ASIC), and “~unit” performs certain functions. However, the “~unit” is not limited to software or hardware. The “~unit” may be configured to reside in an addressable storage medium, or may be configured to reproduce one or more processors. Therefore, for example, “~unit” includes components such as software components, object-oriented software components, class components, and task components, and includes processes, functions, attributes, procedures, sub-routines, segments of program code, drivers, firmware, micro code, circuits, data, a database, data structures, tables, arrays, and variables. Functions provided in the components and the “~unit” may be combined into smaller numbers of components and “~units,” or may be further divided into additional components and “~units.” Furthermore, the components and “~units” may be implemented to reproduce one or more CPUs in a device or a security multimedia card.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

According to an example of the present invention, there is provided an autonomous vehicle control device including a transceiver unit, one or more processors, and a memory storing one or more programs executed by the one or more processors, the transceiver unit is configured to collect a plurality of first coordinates indicating a driving path of a host vehicle in a first region where driving of the host vehicle starts in an arbitrary driving section and collect a plurality of second coordinates indicating a driving path of the host vehicle in a second region where driving of the host vehicle ends in the arbitrary driving section, and the processor is configured to determine a first direction in which the host vehicle is heading at an entry point of the arbitrary driving section using the first coordinates and determine a second direction in which the host vehicle is heading at an end point of the arbitrary driving section using the second coordinates, generate a driving plan path of the host vehicle in the arbitrary driving section using the first coordinates, the second coordinates, the first direction, and the second direction, and control a behavior of the host vehicle according to the driving plan path.

The arbitrary driving section may be a section where map information is missing.

The processor may determine that the map information is missing if an interval of lane center line coordinates is greater than or equal to a preset reference interval.

The first coordinates may include a coordinate at the entry point of the arbitrary driving section and a coordinate at a point directly before entering the arbitrary driving section, and the second coordinates may include a coordinate at the end point of the arbitrary driving section and a coordinate at a point directly after the arbitrary driving section ends.

The processor may determine the first direction by comparing the coordinate at the entry point of the arbitrary driving section with the coordinate at the point directly before entering the arbitrary driving section.

The processor may determine the second direction by comparing the coordinate at the end point of the arbitrary driving section with the coordinate at the point directly after the arbitrary driving section ends.

The processor may determine lane information in the arbitrary driving section using camera information collected through the transceiver unit.

The processor may generate the driving plan path of the host vehicle using the lane information as a boundary.

The processor may determine lane sides using the driving plan path of the host vehicle and the lane information.

The processor may stop generating the driving plan path of the host vehicle if an angle formed by a virtual center point based on the host vehicle and the lane sides is greater than or equal to a reference angle.

According to another example of the present invention, there is provided an autonomous vehicle control method that is performed by a computing device including a transceiver unit, one or more processors, and a memory storing one or more programs executed by the one or more processors, including collecting, by the transceiver unit, a plurality of first coordinates indicating a driving path of a host vehicle in a first region where driving of the host vehicle starts in an arbitrary driving section and collecting a plurality of second coordinates indicating a driving path of the host vehicle in a second region where driving of the host vehicle ends in the arbitrary driving section; and determining, by the processor, a first direction in which the host vehicle is heading at an entry point of the arbitrary driving section using the first coordinates and determining a second direction in which the host vehicle is heading at an end point of the arbitrary driving section using the second coordinates, generating a driving plan path of the host vehicle in the arbitrary driving section using the first coordinates, the second coordinates, the first direction, and the second direction, and controlling a behavior of the host vehicle according to the driving plan path.

The arbitrary driving section may be a section where map information is missing.

The processor may determine that the map information is missing if an interval of lane center line coordinates is greater than or equal to a preset reference interval.

The first coordinates may include a coordinate at the entry point of the arbitrary driving section and a coordinate at a point directly before entering the arbitrary driving section, and the second coordinates may include a coordinate at the end point of the arbitrary driving section and a coordinate at a point directly after the arbitrary driving section ends.

The processor may determine the first direction by comparing the coordinate at the entry point of the arbitrary driving section with the coordinate at the point directly before entering the arbitrary driving section.

The processor may determine the second direction by comparing the coordinate at the end point of the arbitrary driving section with the coordinate at the point directly after the arbitrary driving section ends.

The processor may determine lane information in the arbitrary driving section using camera information collected through the transceiver unit.

The processor may generate the driving plan path of the host vehicle using the lane information as a boundary.

The processor may determine lane sides using the driving plan path of the host vehicle and the lane information.

The processor may stop generating the driving plan path of the host vehicle if an angle formed by a virtual center point based on the host vehicle and the lane sides is greater than or equal to a reference angle.

According to an example, an optimal driving path can be generated by considering the kinematic characteristics of a vehicle even in a section where a HD map has not been built. This can allow an autonomous vehicle to plan a driving path that reflects the physical constraints of the vehicle (e.g., a minimum turning radius, a vehicle size, acceleration, speed limits, and the like) rather than a way of simply following the center of a lane, thereby significantly improving safety and driving stability.

In addition, the present invention can allow a vehicle to adaptively generate a driving path and follow a path optimized for a road environment even in a curved section (e.g., a curved road) where map information is missing by recognizing a lane line of a road utilizing a camera sensor mounted on the vehicle. This provides reliability that allows an autonomous vehicle to smoothly and safely travel even in environments without a HD map.

Therefore, the present invention can expand the possibility of operating an autonomous vehicle even in a road environment where the HD map has not been built, and allow efficient and practical driving path planning and control without relying on an existing HD map-based driving system. This can contribute to increasing adaptability to changes in road environments and reducing the cost and dependency of building the HD map.

Although the preferred examples of the present invention have been described above, it is understood that those skilled in the art may make various changes and modifications to the present invention without departing from the spirit and scope of the present invention set forth in the claims below.

What is claimed is:

1. An apparatus of a vehicle, the apparatus comprising:
a processor; and
a memory storing at least one instruction that, when executed by the processor communicating with the memory, is configured to cause the apparatus to:
obtain, via a transceiver of the vehicle, a plurality of first coordinates indicating a driving path of the vehicle in a first region where driving of the vehicle starts in an arbitrary driving section, wherein the arbitrary driving section corresponds to a section where map information for controlling driving of the vehicle is missing,
obtain, via the transceiver, a plurality of second coordinates indicating a driving path of the vehicle in a second region where driving of the vehicle ends in the arbitrary driving section,
determine, based on the plurality of first coordinates, a first direction in which the vehicle is heading at an entry point of the arbitrary driving section,
determine, based on the plurality of second coordinates, a second direction in which the vehicle is heading at an end point of the arbitrary driving section,
output, based on the first direction and the second direction, a signal indicating a driving plan path of the vehicle in the arbitrary driving section, and
control, based on the signal, autonomous driving of the vehicle.

2. The apparatus of claim 1, wherein the at least one instruction, when executed by the processor communicating with the memory, is configured to cause the apparatus to:
based on an interval of lane center line coordinates being greater than or equal to a preset reference interval, determine that the map information is missing.

3. The apparatus of claim 1, wherein the at least one instruction, when executed by the processor communicating with the memory, is configured to cause the apparatus to output the signal indicating the driving plan path of the vehicle in the arbitrary driving section further based on the first coordinates and the second coordinates.

4. The apparatus of claim 1, wherein the plurality of first coordinates comprise a coordinate at the entry point of the arbitrary driving section and a coordinate at a point immediately before entering the arbitrary driving section, and
the plurality of second coordinates comprise a coordinate at the end point of the arbitrary driving section and a coordinate at a point immediately after the arbitrary driving section ends.

5. The apparatus of claim 4, wherein the at least one instruction, when executed by the processor communicating with the memory, is configured to cause the apparatus to determine the first direction by comparing the coordinate at the entry point of the arbitrary driving section with the coordinate at the point immediately before entering the arbitrary driving section.

6. The apparatus of claim 4, wherein the at least one instruction, when executed by the processor communicating with the memory, is configured to cause the apparatus to determine the second direction by comparing the coordinate at the end point of the arbitrary driving section with the coordinate at the point immediately after the arbitrary driving section ends.

7. The apparatus of claim 1, wherein the at least one instruction, when executed by the processor communicating with the memory, is configured to cause the apparatus to determine, based on sensor information obtained via the transceiver, lane information associated with the arbitrary driving section.

8. The apparatus of claim 7, wherein the at least one instruction, when executed by the processor communicating with the memory, is configured to cause the apparatus to output, based on the lane information, the signal indicating the driving plan path of the vehicle, and wherein the driving plan path comprises boundary information derived from the lane information.

9. The apparatus of claim 7, wherein the at least one instruction, when executed by the processor communicating with the memory, is configured to cause the apparatus to determine, based on the driving plan path of the vehicle and the lane information, lane sides of the arbitrary driving section.

10. The apparatus of claim 9, wherein the at least one instruction, when executed by the processor communicating with the memory, is configured to cause the apparatus to, based on an angle formed by a virtual center point of the vehicle and the lane sides being greater than or equal to a reference angle, stop outputting the signal indicating the driving plan path of the vehicle.

11. A method performed by an apparatus of a vehicle, the method comprising:
obtaining, via a transceiver of the vehicle, a plurality of first coordinates indicating a driving path of the vehicle in a first region where driving of the vehicle starts in an arbitrary driving section, wherein the arbitrary driving section corresponds to a section where map information for controlling driving of the vehicle is missing;
obtaining, via the transceiver, a plurality of second coordinates indicating a driving path of the vehicle in a second region where driving of the vehicle ends in the arbitrary driving section;
determining, based on the plurality of first coordinates, a first direction in which the vehicle is heading at an entry point of the arbitrary driving section;
determining, based on the plurality of second coordinates, a second direction in which the vehicle is heading at an end point of the arbitrary driving section;
outputting, based on the first direction and the second direction, a signal indicating a driving plan path of the vehicle in the arbitrary driving section; and
controlling, based on the signal, autonomous driving of the vehicle.

12. The method of claim 11, further comprising:
based on an interval of lane center line coordinates being greater than or equal to a preset reference interval, determining that the map information is missing.

13. The method of claim 12, wherein the outputting of the signal indicating the driving plan path of the vehicle in the arbitrary driving section is further based on the first coordinates and the second coordinates.

14. The method of claim 11, wherein the plurality of first coordinates comprise a coordinate at the entry point of the arbitrary driving section and a coordinate at a point immediately before entering the arbitrary driving section, and
the plurality of second coordinates comprise a coordinate at the end point of the arbitrary driving section and a coordinate at a point immediately after the arbitrary driving section ends.

15. The method of claim 14, further comprising:
determining the first direction by comparing the coordinate at the entry point of the arbitrary driving section with the coordinate at the point immediately before entering the arbitrary driving section.

16. The method of claim 14, further comprising:
determining the second direction by comparing the coordinate at the end point of the arbitrary driving section with the coordinate at the point immediately after the arbitrary driving section ends.

17. The method of claim 11, further comprising:
determining, based on sensor information obtained via the transceiver, lane information in the arbitrary driving section.

18. The method of claim 17, wherein the outputting of the signal indicating the driving plan path of the vehicle comprises outputting, based on the lane information, the signal indicating the driving plan path of the vehicle, and wherein the driving plan path comprises boundary information derived from the lane information.

19. A vehicle comprising:
a sensor;
a transceiver;
a processor; and
a memory storing at least one instruction that, when executed by the processor communicating with the memory, is configured to cause the vehicle to:
obtain, via the transceiver,
first coordinate data representing a driving path of the vehicle in a first region where the vehicle begins to travel in a road section lacking map information, and
second coordinate data representing a driving path of the vehicle in a second region where the vehicle ends the travel in the road section,
determine, based on the first coordinate data, a first direction of the travel at an entry point of the road section,
determine, based on the second coordinate data, a second direction of the travel at an exit point of the road section,
generate driving path data representing a trajectory from the entry point to the exit point, the trajectory satisfying the first direction and the second direction and connecting the entry point to the exit point,
identify, based on sensor data obtained from the sensor, a left lane boundary and a right lane boundary in the road section,
adjust the driving path data such that the trajectory represented by the driving path data is located between the left lane boundary and the right lane boundary, output a signal indicating the adjusted driving path data, and
control, based on the signal, autonomous driving of the vehicle.

20. The vehicle of claim 19, wherein at least one instruction, when executed by the processor communicating with the memory, is configured to cause the vehicle to:
determine a left lane edge and a right lane edge by, for each of a plurality of points along the trajectory represented by the driving path data, drawing a perpendicular line to the left lane boundary and to the right lane boundary, and identifying intersection points of the perpendicular line and the lane boundaries as the left lane edge and the right lane edge, and
based on an angle, formed at a virtual front-center point of the vehicle between a first line segment extending from the virtual front-center point to the left lane edge and a second line segment extending from the virtual front-center point to the right lane edge, being greater than or equal to a threshold angle, stop generation of the driving path data.
